(19) United States
(12) Patent Application Publication
(10) Pub. No.: US 2024/0141710 A1
(43) Pub. Date: May 2, 2024

(54) VEHICLE TRUNK HINGE

(71) Applicant: CVF Motorsports, Inc., New Prague, MN (US)

(72) Inventor: Joseph K. Vail, Lonsdale, MN (US)

(21) Appl. No.: 18/498,355

(22) Filed: Oct. 31, 2023

Related U.S. Application Data
(60) Provisional application No. 63/420,462, filed on Oct. 28, 2022.

(51) Int. Cl. E05F 15/53; B62D 25/12; E05D 3/12; E05D 5/06; E05D 7/00; E05D 7/04

(52) U.S. Cl. CPC E05F 15/53; B62D 25/12; E05D 3/125; E05D 5/062; E05D 7/0045; E05D 7/04; E05D 2005/067; E05D 2007/0469; E05Y 2600/12; E05Y 2600/31; E05Y 2900/548

(57) ABSTRACT

A trunk hinge includes a mounting plate configured to be attached to a vehicle, a pivot block pivotally coupled to the mounting plate, a strut pivotally coupled to the mounting plate, a hinge arm pivotally coupled to the strut, and an adjustment mechanism connecting the pivot block to the hinge arm. The adjustment mechanism can enable relative movement between a reference point of the pivot block and the hinge arm.

### CROSS REFERENCE TO RELATED APPLICATION

This application claims the benefit of U.S. Provisional Application No. 63/420,762, filed Oct. 31, 2022, the content of which is hereby incorporated by reference in its entirety.

### TECHNICAL FIELD

This disclosure relates generally to hinges for vehicle trunks.

### BACKGROUND

Known hinges for attaching replacement trunks to vehicles have limited adjustment. This adjustment is usually accomplished using loose tolerance on bolt holes and/or slots in the holes for bolts that connect the trunk and the body of the vehicle to the hinge. This can be very time-consuming as it typically requires multiple iterations by a team of installers to fine-tune gaps between body panels and the trunk of the vehicle.

Another known solution for automotive hinge alignment is to use shims to fine-tune the fit of a replacement trunk. This is also a time-consuming and iterative process that requires the installation team to remove the trunk and hinge, add shims, and re-install the trunk and hinge.

### SUMMARY

The present disclosure describes various embodiments of a trunk hinge. Advantages of the trunk hinge embodiments described herein include an ability to easily adjust a trunk hinge via an adjustment mechanism to align an opening and closing of the attached trunk.

One embodiment includes a body attachment member configured to be attached to a body of a vehicle and a trunk attachment member configured to be attached to a trunk of the vehicle. The embodiment further includes a strut connected to the body attachment member and to the trunk attachment member and a pivot block pivotally connected to the body attachment member. The pivot block is adjustably connected to the trunk attachment member via an adjustment mechanism with the adjustment mechanism configured to enable relative movement between the pivot block and the trunk attachment member.

In another embodiment, a trunk hinge comprises a mounting plate configured to be attached to a body of a vehicle and a pivot block pivotally coupled to the mounting plate. The embodiment further includes a strut having a first strut end and a second strut end with the first strut end being pivotally coupled to the mounting plate. The embodiment also includes a hinge arm pivotally coupled to the strut at the second strut end and connected to the pivot block by a leadscrew through a locknut. The leadscrew and the locknut are configured to enable relative movement between the hinge arm and the pivot block with the hinge arm configured to be attached to a trunk of the vehicle.

In another embodiment, a trunk hinge comprises a pivot block configured to be attached to a body of a vehicle and a trunk attachment member configured to be attached to a trunk of the vehicle. The embodiment also includes a strut configured to be attached to the body of the vehicle at a first strut end and connected to the trunk attachment member at a second strut end with the strut configured to enable hinged movement of the trunk relative to the body of the vehicle. The embodiment further includes an adjustment mechanism connecting the pivot block to the trunk attachment member and configured to enable relative movement between the pivot block and the trunk attachment member.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a side view of an embodiment of a trunk hinge in a closed configuration according to an aspect of the present disclosure.

FIG. 2 is a side view of the embodiment of the trunk hinge of FIG. 1 in an open configuration according to an aspect of the present disclosure.

FIG. 3 is an enlarged sectional view of an adjustment mechanism of the trunk hinge of FIG. 1 according to an aspect of the present disclosure.

FIG. 4 is an enlarged view of a pivot block of the trunk hinge of FIG. 1 according to an aspect of the present disclosure.

FIG. 5A is a perspective view of a pivot block of a trunk hinge according to an aspect of the present disclosure.

FIG. 5B is a side sectional view of the pivot block of FIG. 5A according to an aspect of the present disclosure.

FIG. 6A is a perspective view of a hinge arm of a trunk hinge according to an aspect of the present disclosure.

FIG. 6B is a side sectional view of the hinge arm of FIG. 6A according to an aspect of the present disclosure.

FIG. 7A is a top view of a trunk attachment member of an illustrative trunk hinge, showing the first and second cam buttons in downward positions.

FIG. 7B is a top view of a trunk attachment member of an illustrative trunk hinge, showing the first and second cam buttons each rotated into upward positions.

FIG. 7C is a top view of a trunk attachment member of an illustrative trunk hinge, showing the second cam button in an upward position and the first cam button rotated into a downward position.

FIG. 8A is a top view of a trunk attachment member of an illustrative trunk hinge.

FIG. 8B is a top view of a trunk attachment member of an illustrative trunk hinge, showing the trunk attachment member threaded fastener pressing into the first cam assembly.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

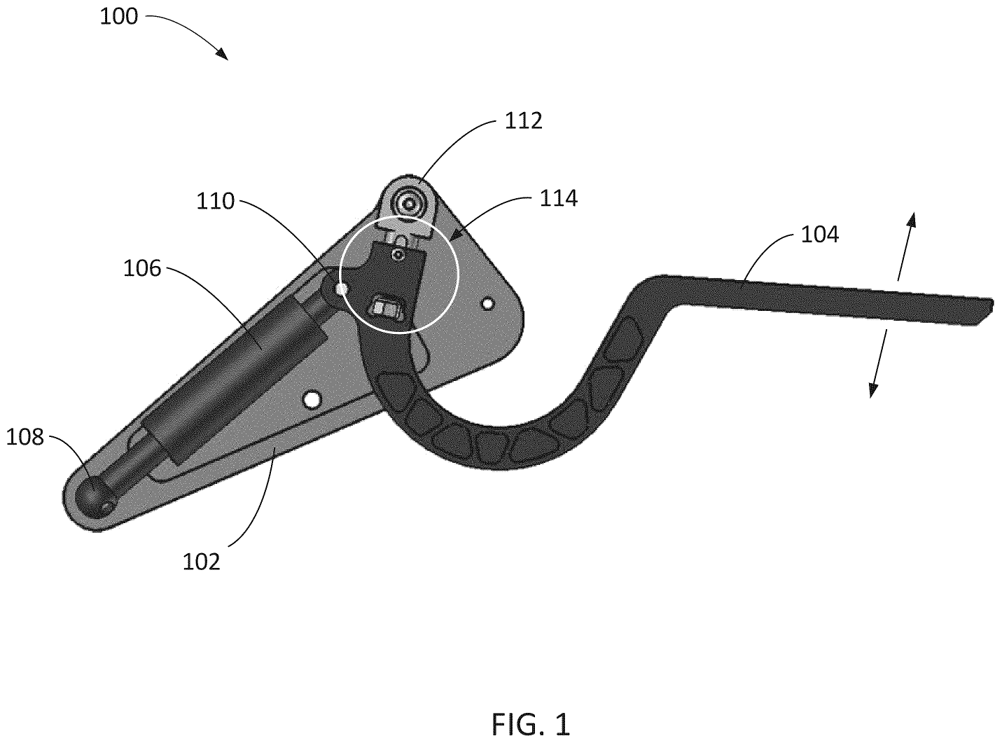

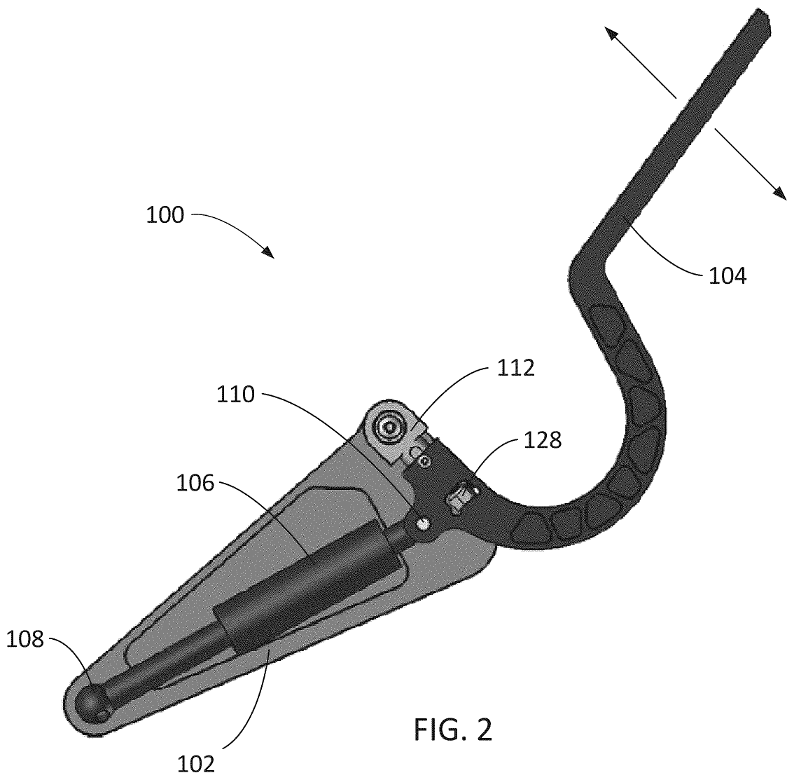

FIG. 1 illustrates one embodiment of a trunk hinge 100 in a closed configuration according to an aspect of the present disclosure. FIG. 2 illustrates the embodiment of the trunk hinge 100 of FIG. 1 in an open configuration according to an aspect of the present disclosure. Referencing both FIG. 1 and FIG. 2, the trunk hinge 100 comprises a mounting plate 102, a hinge arm 104, a strut 106, a pivot block 112, and an adjustment mechanism 114. The mounting plate 102 attaches to a vehicle while the hinge arm 104 attaches to a trunk (not illustrated). The strut 106, the pivot block 112, and the adjustment mechanism 114 enable the trunk hinge to operate, whereby the hinge arm moves between an open position and a closed position. The adjustment mechanism 114 can also adjust a positioning of the hinge arm 104 relative to the pivot block 112 such that a trunk attached to the hinge arm 104 can be positioned properly for a vehicle. As illustrated by the arrows in FIG. 1 and FIG. 2, the adjustment mechanism 114 can adjust the height and reach/extension of the hinge arm 104 on which a vehicle's trunk attaches.

The mounting plate 102 of the trunk hinge 100 can define a series of mounting holes that accept fasteners (e.g., bolts) to secure the mounting plate 102 to an interior of a vehicle's trunk. The mounting holes can be located in a variety of locations on the mounting plate 102 and have a variety of sizes to fit a variety of different vehicles. The mounting plate 102 can also have any shape and size in order to fit various vehicles. In some embodiments, such as in FIG. 1 and FIG. 2, the mounting plate 102 has a triangular shape that fits numerous vehicles and is mechanically strong. In some such embodiments, mounting holes can be located proximate to each corner of the triangular shape. In some embodiments, the mounting plate 102 is referred to as a vehicle attachment member as it attaches to a vehicle.

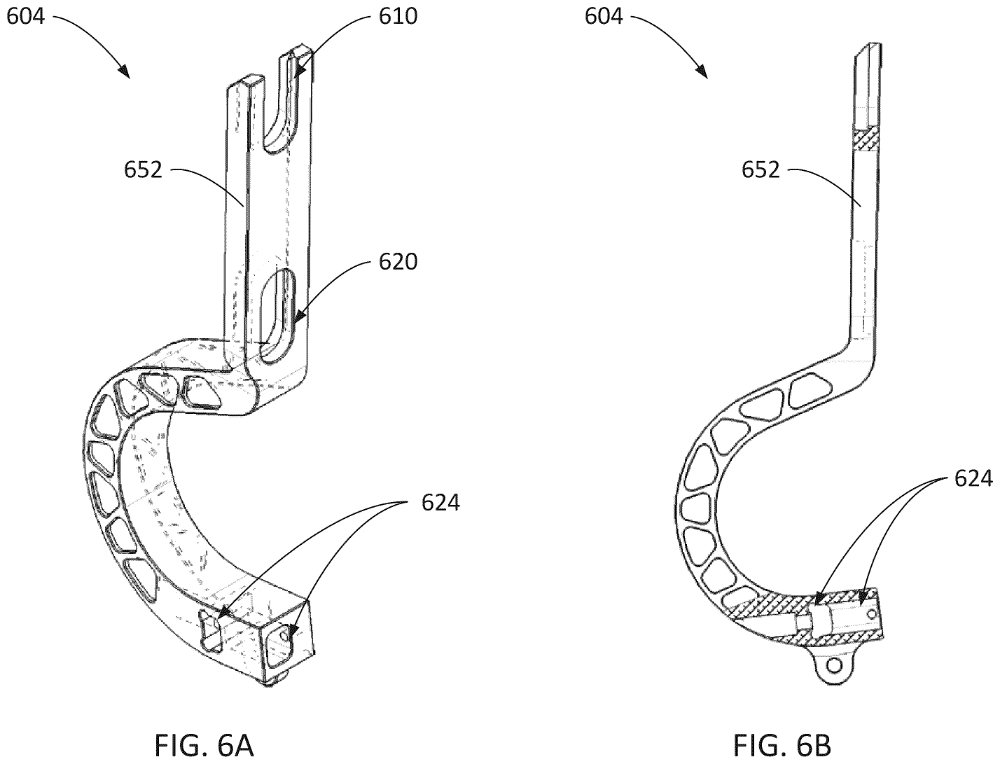

The hinge arm 104 of the trunk hinge 100 attaches to the strut 106 and to the pivot block 112 of the trunk hinge 100 and can be further attached to a trunk. The hinge arm 104 is shaped to include a U-like bend as well as having an extended portion onto which the trunk secures. The hinge arm 104 secures the trunk to the vehicle via its connection to the strut 106 and the pivot block 112, which are secured to mounting plate 102, which is secured to the vehicle. More detailed images of a hinge arm are found in FIG. 6.

The strut 106 of the trunk hinge 100 includes a first strut end 108 connected to the mounting plate 102 and a second strut end 110 connected to the hinge arm 104. The first strut end 108 is pivotally coupled to the mounting plate 102 and the second strut end 110 is pivotally coupled to the hinge arm 104. Pivotally coupling the first strut end 108 to the mounting plate 102 and the second strut end 110 to the hinge arm 104 enables the strut to compress and expand while moving the hinge arm 104. The strut 106 is configured to resist being compressed. For example, the strut can be filled with a gas, fluid, spring, or the like that resists compression. As the first strut end 108 is pivotally coupled to the mounting plate 102, which is secured to a vehicle, and the second strut end 110 is pivotally coupled to the hinge arm 104, which is secured to a trunk, the strut's resistance to compression provides a force biasing the hinge arm 104 and the attached trunk toward an open position. This configuration can enable the trunk hinge 100 to open an attached trunk when the trunk is unlatched, for instance. In FIG. 1, the strut 106 is in a compressed position with the hinge arm 104 attached to a trunk being in a closed position. In contrast, the strut 106 of FIG. 2 is in an expanded position with the hinge arm 104 attached to the trunk being in an open position.

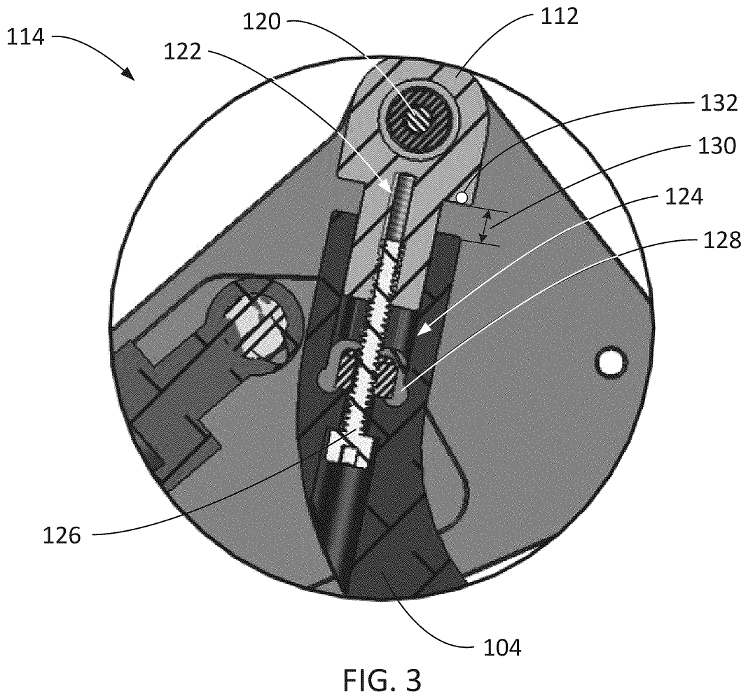

The pivot block 112 of the trunk hinge 100 is pivotally coupled to the mounting plate 102 and is further coupled to the hinge arm 104. The pivot block 112 can be pivotally coupled to the mounting plate 102 about a pivot center. The hinge arm 104 rotates about the pivot center of the pivot block 112 when it moves between a closed configuration (e.g., FIG. 1) and an open configuration (e.g., FIG. 2). In the embodiment of FIG. 1 and FIG. 2, the pivot block 112 is adjustably coupled to the hinge arm 104 via an adjustment mechanism 114. The adjustment mechanism 114 comprises a series of components and is described with reference to FIG. 3.

FIG. 3 is an enlarged sectional view of the adjustment mechanism 114 of the trunk hinge 100 of FIG. 1 according to an aspect of the present disclosure. The adjustment mechanism 114 includes a pivot block 112 that pivots about a pivot center 120 and defines a threaded hole 122. The adjustment mechanism 114 also includes a hinge arm 104 that defines an opening 124. The opening 124 is sized to fit a portion of the pivot block 112 inside the opening 124. The opening 124 can also extend through the hinge arm. The adjustment mechanism 114 further includes a threaded fastener 126 and a nut 128. The nut 128 is sized to fit inside a portion of the opening 124 and is threaded to accept the threaded fastener 126. In some examples, the nut is referred to as a locknut or threaded receiving member. The threaded fastener 126 can fit through the opening 124 of the hinge arm 104, can threadibly engage the nut 128, and can threadibly secure to the threaded hole 122 of the pivot block.

In operation, the adjustment mechanism 114 can adjust a spacing 130 that exists between the pivot block 112 and the hinge arm 104. For example, the adjustment mechanism 114 can adjust the spacing 130 between a reference point 132 of the pivot block 112 and the hinge arm 104. The illustrated reference point 132 of FIG. 3 is only one example of a reference point, as a reference point can encompass various points on the pivot block 112. Adjusting the spacing between the pivot block 112 and the hinge arm 104 can change the position of the hinge arm 104 when it is in a closed configuration or open configuration.

To adjust the spacing 130 between the pivot block 112 and the hinge arm 104, the threaded fastener 126 is screwed into or out of the threaded hole 122. For example, to decrease the spacing 130, the threaded fastener 126 is screwed further into the threaded hole 122 of the pivot block 112. To increase the spacing 130, the threaded fastener 126 is screwed further out of the threaded hole 122 of the pivot block 112. In some embodiments, a user can screw in/out the threaded fastener 126 using a tool (e.g., a hex wrench) that can access a head 134 of the threaded fastener 126 through a slot 136 in the hinge arm 104.

To fix the spacing 130 between the pivot block 112 and the hinge arm 104 after adjustment, the threaded fastener 126 is threaded through a nut 128 before screwing into the threaded hole 122. The nut 128 can sit within a portion of the opening 124 of the hinge arm 104 and can receive the threaded fastener 126. As illustrated, the head 134 of the threaded fastener 126 is in the slot 136 of the hinge arm 104, and the nut 128 is in the hinge arm opening 124. Such a configuration enables the threaded fastener 126 and the nut 128 to screw toward each other to clamp a portion of the hinge arm 104 as is illustrated in FIG. 3. Clamping the portion of the hinge arm 104 can fix the hinge arm 104 in position relative to the pivot block 112. Similarly, such a configuration enables the threaded fastener 126 and the nut 128 to screw away from each other to release the portion of the hinge arm 104. In some examples, releasing the portion of the hinge arm 104 allows a user to adjust the spacing 130 between the pivot block 112 and the hinge arm 104 by screwing the threaded fastener 126 further into/out of the threaded hole 122 of the pivot block 112. In such examples, the user can then rotate/tighten the nut 128 relative to the threaded fastener 126 to again clamp the portion of the hinge arm 104 to fix the selected spacing 130. The user can access the nut 128 through a side access 138. In some embodiments, screwing the threaded fastener 126 further into/out of the threaded hole 122 when the nut 128 is loose (e.g., not clamping the hinge arm 104) causes the nut 128 to rotate in the same direction as the threaded fastener 126. In some examples, a user can adjust the spacing 130 between the pivot block 112 and the hinge arm 104 by screwing the threaded fastener 126 further into/out of the threaded hole 122 of the pivot block 112 without loosening the nut 138. In some such examples, the nut 138 can remain clamping the hinge arm 104 but enable the threaded fastener 126 to screw further into/out of the threaded hole 122.

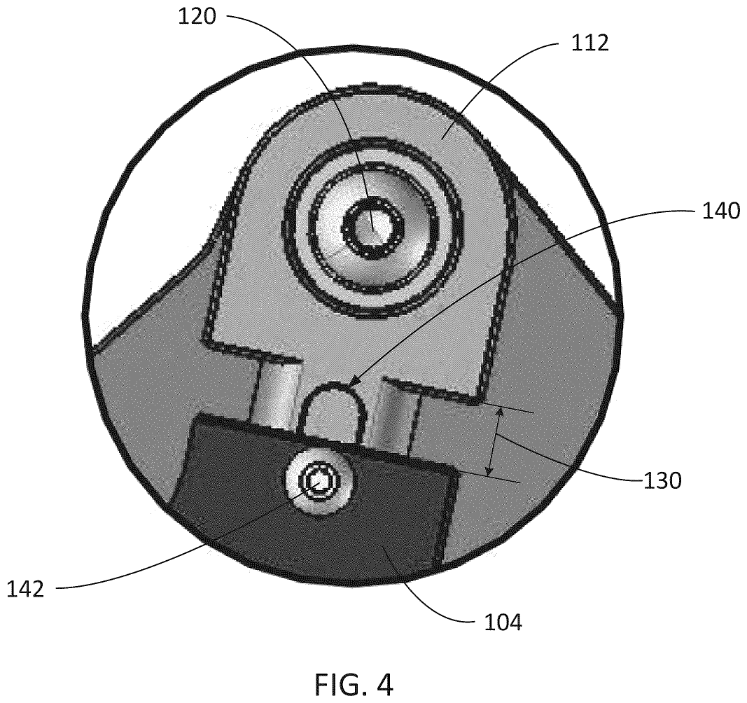

Moving to FIG. 4, FIG. 4 is an enlarged view of a pivot block 112 of the trunk hinge 100 of FIG. 1 according to an aspect of the present disclosure. The pivot block 112 defines a slot 140 having a first end and a second end. The hinge arm 104 includes a stopping member 142 that is sized to fit in the slot 140. In some embodiments, the hinge arm 104 defines a stopping member opening in which the stopping member threadibly engages and passes through. The stopping member 142 extends into the slot 140 between the first end and the second end. The stopping member 142 can move with the hinge arm 104 if a spacing 130 between the hinge arm 104 and the pivot block 112 changes and can limit the relative movement between the hinge arm 104 and the pivot block 112. For example, in the illustrated embodiment of FIG. 4, a minimum size of the spacing 130 is limited by when the stopping member 142 contacts a first end of the slot 140. In contrast, a maximum size of the spacing 130 is limited by when the stopping member 142 contacts a second end of the slot 140. In some embodiments, a difference between the minimum size of the spacing 130 and a maximum size of the spacing can be limited to approximately 0.5 inches. Including the stopping member 142 and the corresponding slot 140 can prevent a user from unscrewing the threaded fastener 126 from the pivot block too much so as to compromise safety or uncouple the pivot block 112 from the hinge arm 104. Further, including the stopping member 142 and the corresponding slot 140 can prevent a user from over-tightening the threaded fastener 126 into the pivot block 112.

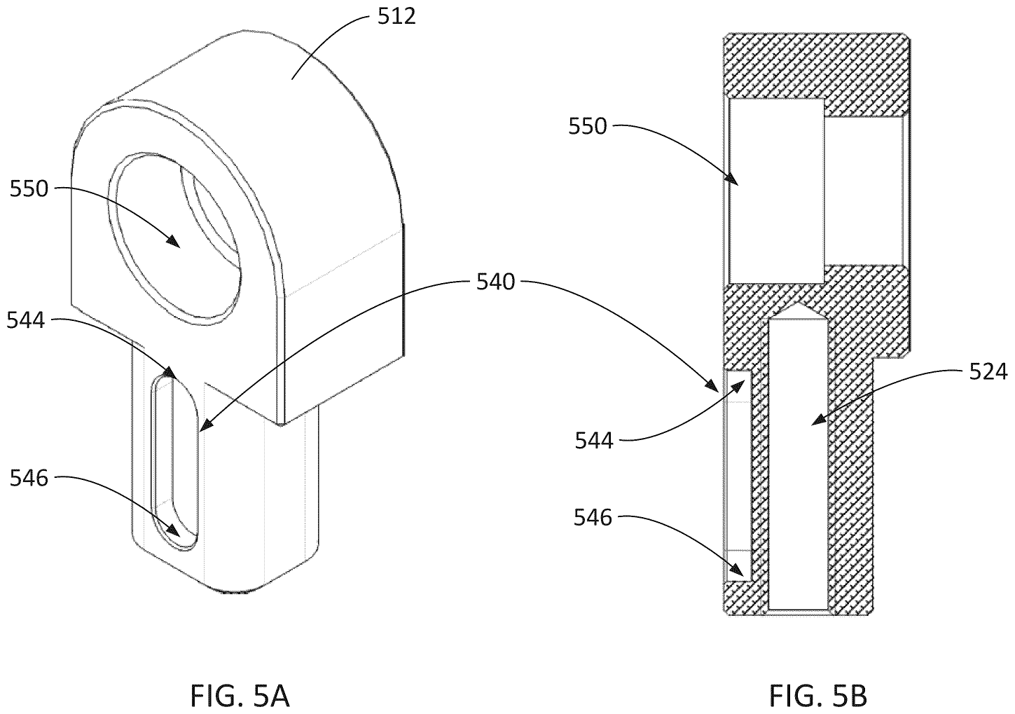

Moving to FIG. 5A and FIG. 5B, FIG. 5A is a perspective view of a pivot block 512 of a trunk hinge, and FIG. 5B is a side sectional view of the pivot block of FIG. 5A. The pivot block 512 defines a slot 540 having a first end 544 and a second end 546. As described with respect to FIG. 4, the slot 540 is sized to receive a stopping member (e.g., 142). As best illustrated in FIG. 5B, the slot 540 of this embodiment does not pass through the entire pivot block 512, extending inward for only a small portion of the pivot block's thickness. The pivot block 512 further defines a threaded hole 524. The threaded hole 524 is sized to accept a threaded fastener such as the threaded fastener of FIG. 3. The pivot block 512 also defines a pivot hole 550 that is sized to accept a fastener to pivotally connect the pivot block 512 to a mounting plate (e.g., mounting plate 102 of FIG. 1). In some embodiments, the pivot hole 550 is sized to accept a bearing.

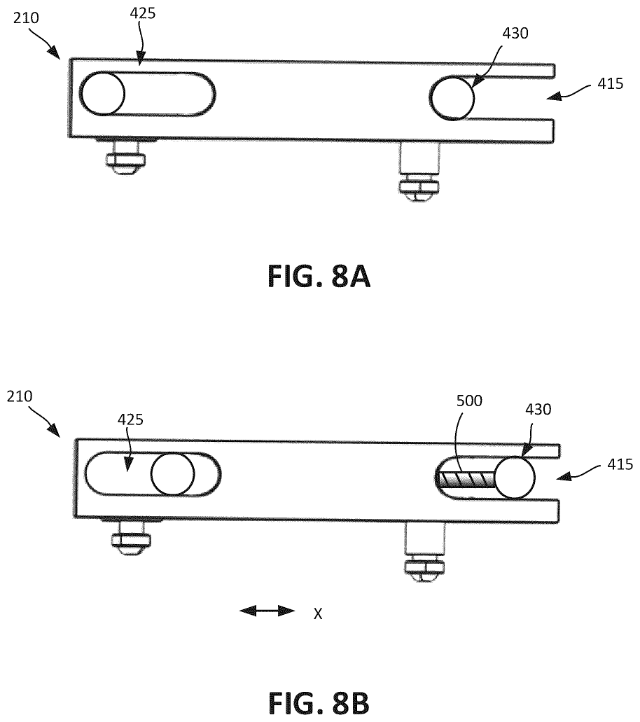

Moving to FIGS. 6A and 6B, FIG. 6A is a perspective view of a hinge arm 604 of a trunk hinge, and FIG. 6B is a side sectional view of the hinge arm 604 of FIG. 6A. The hinge arm 604 can comprise an attachment arm 652 that attaches to a trunk. The hinge arm 604 defines multiple openings including an opening 624. As described elsewhere herein, the opening 624 can accept a portion of a pivot block (e.g., 112), and a nut (e.g., 128) can be accessed by a user through a side access 626. The hinge arm 604, and specifically the attachment arm 652, can define a first attachment opening 610 and a second attachment opening 620. The first attachment opening 610 and the second attachment opening 620 are used to secure a trunk of a vehicle to the hinge arm 604. For instance, in some embodiments, a bolt can pass through each of the first attachment opening 610 and the second attachment opening 620 and secure to a trunk. Due to the open-ended shape of the first attachment opening 610, an initial placement of a hood can be facilitated. For example, an initial bolt can be secured to a hood and can then rest inside the first attachment opening 610 to aid in securing a trunk to the attachment arm 652. Additionally, due to the oval shape of the second attachment opening 620, the hinge arm 604 can adjustably secure to the trunk as is described further with respect to FIGS. 8A-8B.

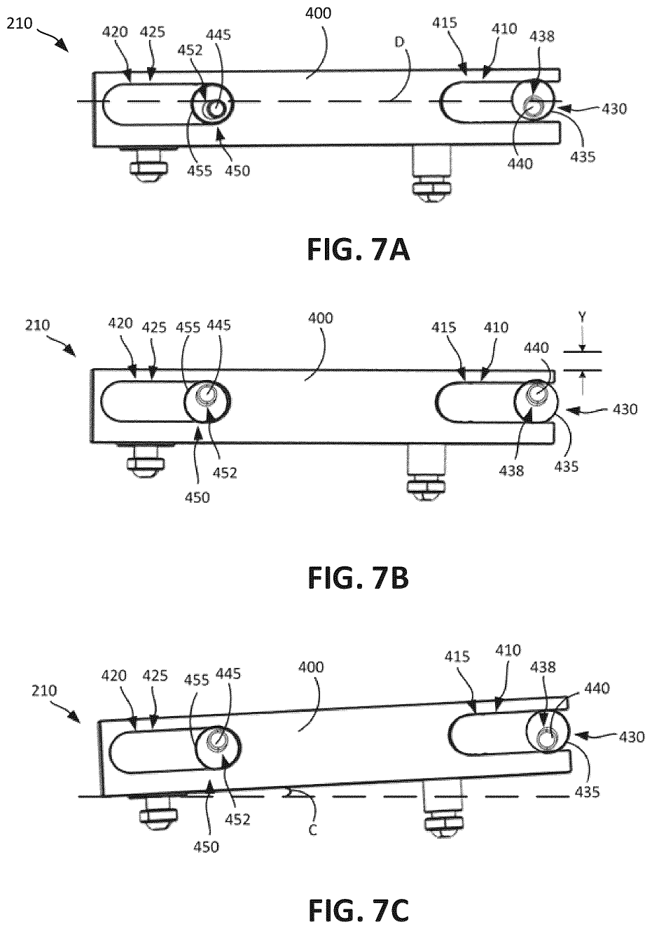

Moving to FIGS. 7A-7C, the hinge arm 210 can include a first attachment opening 410 and a second attachment opening 420. The hinge arm 210 can include a first cam assembly 430 configured to allow adjustment of the trunk from side to side relative to a vehicle body. As shown in FIGS. 7A-7C, the first cam assembly 430 can include a first cam button 435 and a first bolt 440. The first bolt 440 can extend through an opening 438 in the first cam button 435. The first bolt 440 can be configured to attach the hinge arm 400 to the trunk of the vehicle while positioning the first cam button 435 in the first attachment opening 410. The first cam assembly 430 can be configured to permit controlled adjustment of a position of the trunk relative to the hinge arm 400 in a first direction perpendicular to a longitudinal axis D of the hinge arm 210.

As shown in FIGS. 7A-7C, the hinge arm 210 can include a second cam assembly 450. The second cam assembly 450 can include a second cam button 455 and a second bolt 445. In such embodiments, the second bolt 445 can extend through an opening 452 in the second cam button 455 and can be configured to position the second cam button 455 in the second attachment opening 420. The second cam assembly 450 is configured to permit adjustment of the position of the trunk relative to the hinge arm 400 in the first direction, independent of the first cam assembly 430 permitting adjustment of the position of the trunk relative to the hinge arm 400 in the first direction. In some embodiments, by virtue of the first cam assembly 430 and second cam assembly 450, the illustrative trunk hinge 100 can allow for 0.125-inch adjustment in both directions perpendicular to longitudinal axis D for a total adjustable range of 0.25 inches.

FIG. 7A shows the first and second cam buttons 435, 455 each in a first position, with cam bolts 440, 445 facing downward on the page, whereas FIG. 7B shows the first and second cam buttons 435, 455 each rotated 180 degrees into a second position, with cam bolts 440, 445 facing upward on the page. This rotation of the first and second cam buttons 435, 455 (from the position shown in FIG. 7A to the position shown in FIG. 7B) can be configured to adjust the position of the trunk relative to the hinge arm 400 by a distance Y.

As can be appreciated by comparing FIGS. 7B and 7C, by positioning the first cam button 435 and the second cam button 455 in opposite directions (e.g., such that the first cam bolt 440 is positioned downwardly and the second cam bolt 445 is positioned upwardly), the angle C of the trunk relative to the hinge arm 400 can be adjusted. Advantageously, this adjustment can help properly align the position of the trunk in the vehicle body's trunk opening.

Adjustment of the first and second cam assemblies 430, 450 can permit fine tuning of the position of the hinge arm 400 relative to the trunk. For example, the trunk can be manually translated slightly in a side-to-side direction, and the first and second cam buttons 435, 455 can be rotated about the respective cam bolts 445, 440 until the trunk fits well with the vehicle's trunk opening, and then the cam bolts 445, 440 can be tightened. In another example, the trunk can be manually rotated slightly at a particular angle, and the first cam button 435 and/or the second cam button 455 can be rotated about the respective cam bolts 445, 440 until the trunk fits well with the vehicles trunk opening, and then the cam bolts 445, 440 can be tightened. In some instances, the trunk can be translated side to side and rotated, and the first cam button 435 and/or the second cam button 455 can be rotated about the respective cam bolts 445, 440 until the trunk fits well with the vehicle's trunk opening, and then the cam bolts 445, 440 can be tightened.

FIGS. 8A-8B show how the first attachment opening can comprise a first attachment slot 415 and how the second attachment opening can comprise a second attachment slot 425. The first attachment slot 415 and the second attachment slot 425 can be configured to permit adjustment of the position of the trunk relative to the hinge arm 400 in the X direction (parallel with the longitudinal axis of the trunk attachment member). For example, the trunk can be translated in a front-to-back (or back-to-front) direction until the trunk fits well in the vehicle's trunk opening, and the cam bolts 445, 440 can be tightened.

FIGS. 8A-8B show how a trunk attachment member threaded fastener 500 can be incorporated into some embodiments of the hinge arm 210. As shown in FIG. 8B, the trunk attachment member threaded fastener 500 can extend into the first attachment slot 415. The trunk attachment member threaded fastener 500 can be configured to press the first cam assembly 430 to facilitate controlled adjustment of the position of the trunk relative to the hinge arm 400 in the X direction. For example, the trunk can be translated in a front-to-back (or back-to-front) direction until the trunk fits generally well in the vehicle's trunk opening, and then the trunk attachment member threaded fastener 500 can be extended or retracted to press the first cam assembly 430, thereby facilitating an even better fit. As can be appreciated, the trunk attachment member threaded fastener 500 is not visible in FIG. 8A, as it is fully retracted into the hinge arm 210. In many embodiments, the trunk attachment member threaded fastener 500 comprises a set screw.

Advantages of the trunk hinge embodiments described herein include an ability to easily adjust the hinge via an adjustment mechanism to align an opening and closing of the attached trunk. In comparison to existing solutions, the trunk hinge embodiments described herein do not require the removal of any part of the trunk hinge after it is secured to a vehicle to make the adjustments. Further, it may reduce time spent adjusting the trunk hinge to properly fit a vehicle. For example, a user can easily loosen a nut of the attachment mechanism and screw in/out the adjustment mechanism to make adjustments. In some examples, a user need not loosen the nut of the attachment mechanism to screw in/out the adjustment mechanism and make adjustments. In comparison, existing solutions may require removal of the trunk, the trunk hinge, and/or adding/removing shims. Additionally, existing solutions may incorporate loose tolerances to enable adjustment. However, these loose tolerances may require an extensive amount of time to adjust and may increase the chance of fasteners becoming loose. The trunk hinge also comprises cam assemblies which can provide further adjustment of the trunk.

In most instances, the trunk hinges discussed herein are used in pairs, with one trunk hinge being positioned near the right side of the vehicle and the other trunk hinge being positioned on the left side of the vehicle. Using both trunk hinges to make the positional adjustments to the trunk relative to the vehicle multiplies the adjustability as compared with using only one trunk hinge.

Various examples have been described. These and other examples are within the scope of the following claims.

What is claimed is:

1. A trunk hinge, comprising:
a body attachment member configured to be attached to a body of a vehicle;
a trunk attachment member configured to be attached to a trunk of the vehicle;
a strut connected to the body attachment member and to the trunk attachment member; and
a pivot block pivotally connected to the body attachment member and adjustably connected to the trunk attachment member via an adjustment mechanism, the adjustment mechanism configured to enable relative movement between the pivot block and the trunk attachment member.

2. The trunk hinge of claim 1, wherein:
the pivot block includes a pivot block reference point; and
the adjustment mechanism adjusts a spacing between the pivot block reference point and the trunk attachment member.

3. The trunk hinge of claim 2, wherein:
the adjustment mechanism comprises a threaded fastener and a locknut;
the pivot block defines a threaded hole; and
the threaded fastener passes through a portion of the trunk attachment member and threadibly engages with the locknut and the threaded hole, the threaded fastener and the locknut being configured to adjust the spacing between the pivot block reference point and the trunk attachment member.

4. The trunk hinge of claim 3, wherein:
the threaded fastener and the locknut are configured to rotate together relative to the threaded hole; and
rotating the threaded fastener and the locknut relative to the threaded hole causes the spacing between the pivot block reference point and the trunk attachment member to increase or decrease.

5. The trunk hinge of claim 1, wherein:
the trunk attachment member includes a stopping member;
the pivot block defines a slot with first and second ends;
the slot is configured to receive the stopping member; and
the stopping member contacts the first end of the slot to define a maximum spacing between the pivot block reference point and the trunk attachment member and contacts the second end of the slot to define a minimum spacing between the pivot block reference point and the trunk attachment member.

6. The trunk hinge of claim 5, wherein a difference between the minimum spacing and the maximum spacing is approximately 0.5 inches.

7. The trunk hinge of claim 1, wherein the trunk attachment member comprises an attachment arm, the attachment arm configured to attach to the trunk, the attachment arm defining a first attachment opening and a second attachment opening.

8. The trunk hinge of claim 7, further comprising:
a first cam assembly that includes a first cam button and a first bolt, the first bolt being configured to attach the attachment arm to the trunk through the first cam button in the first attachment opening;
a second cam assembly that includes a second cam button and a second bolt, the second bolt being configured to attach the attachment arm to the trunk through the second cam button in the second attachment opening; wherein
the first cam assembly is configured to permit adjustment of a position of the trunk relative to the attachment arm in a first direction;
the second cam assembly is configured to permit adjustment of the position of the trunk relative to the attachment arm in the first direction independent of the first cam assembly permitting adjustment of the position of the trunk relative to the attachment arm in the first direction; and
the first attachment opening and the second attachment opening are configured to permit adjustment of the position of the trunk relative to the attachment arm in a second direction.

9. The trunk hinge of claim 1, wherein the body attachment member defines one or more mounting holes each configured to receive a fastener to attach the body attachment member to the body of the vehicle, the one or more mounting holes sized and spaced to align with one or more mounting holes defined by the body of the vehicle.

10. The trunk hinge of claim 1, wherein the strut comprises a gas strut.

11. A trunk hinge, comprising:
a mounting plate configured to be attached to a body of a vehicle;
a pivot block pivotally coupled to the mounting plate;
a strut having a first strut end and a second strut end, the first strut end being pivotally coupled to the mounting plate; and
a hinge arm pivotally coupled to the strut at the second strut end and connected to the pivot block by a leadscrew through a locknut, the leadscrew and the locknut configured to enable relative movement between the hinge arm and the pivot block, the hinge arm configured to be attached to a trunk of the vehicle.

12. The trunk hinge of claim 11, wherein:
the pivot block includes a pivot block reference point;
rotation of the leadscrew relative to the pivot block in a first direction increases a spacing between the pivot block reference point and the hinge arm; and
rotation of the leadscrew relative to the pivot block in a second direction opposite the first direction decreases the spacing between the pivot block reference point and the hinge arm.

13. The trunk hinge of claim 12, wherein:
rotation of the locknut relative to the leadscrew in a third direction enables the leadscrew to rotate; and
rotation of the locknut relative to the leadscrew in a fourth direction opposite the first direction prevents the leadscrew from rotating.

14. The trunk hinge of claim 13, wherein:
the hinge arm defines an opening proximate the pivot block configured to accept the locknut; and
the locknut is accessible by a user to turn relative to the leadscrew via the opening.

15. The trunk hinge of claim 11, wherein the hinge arm defines one or more attachment openings, each attachment opening configured to receive a fastener for attaching the hinge arm to the trunk of the vehicle.

16. The trunk hinge of claim 15, wherein a first attachment opening of the one or more attachment openings defined by the hinge arm is open-ended to facilitate initial placement of a trunk attachment bolt in the first attachment opening.

17. A trunk hinge, comprising:
a pivot block configured to be attached to a body of a vehicle;
a trunk attachment member configured to be attached to a trunk of the vehicle;
a strut configured to be attached to the body of the vehicle at a first strut end and connected to the trunk attachment member at a second strut end, the strut further configured to enable hinged movement of the trunk relative to the body of the vehicle; and
an adjustment mechanism connecting the pivot block to the trunk attachment member and configured to enable relative movement between the pivot block and the trunk attachment member.

18. The trunk hinge of claim 17, further comprising a stopping member, the stopping member configured to limit the relative movement between the pivot block and the trunk attachment member.

19. The trunk hinge of claim 17, wherein the adjustment mechanism further comprises a threaded fastener and a threaded receiving member, the threaded fastener configured to pass through a portion of the trunk attachment member, and threadibly engage the threaded receiving member and the pivot block.

20. The trunk hinge of claim 17, further comprising a mounting plate configured to be attached to the body of the vehicle, wherein the first strut end and the pivot block are attached to the mounting plate.
